(19) United States
(12) Patent Application Publication
(10) Pub. No.: US 2008/0274781 A1
(43) Pub. Date: Nov. 6, 2008

(54) Video Card Game Machine

(76) Inventor: James Phillips McCann, County Louth (IE)

Correspondence Address: BIRCH STEWART KOLASCH & BIRCH, PO BOX 747, FALLS CHURCH, VA, 22040-0747, US

(21) Appl. No.: 10/586,747

(22) PCT Filed: Jan. 24, 2005
(86) PCT No.: PCT/IE2005/000002

§ 371 Date: May 29, 2007

(30) Foreign Application Priority Data
Jan. 22, 2004 (IE) S2004/0039

(51) Int. Cl. A63F 9/24; G06F 9/44

(52) U.S. Cl. 463/13; 717/106

(57) ABSTRACT

There is provided a video card game machine, having a visual display unit (VDIU), a user control panel for a control unit, means for awarding a prize such as a coin/token delivery hopper, and acceptance means to receive an input payment from a player such as a coin/token acceptor. The VDU is adapted to provide various displays one of which is illustrated. The VDU displays cards, a number of cards from the one pack of cards, namely, a line of winning cards 10(a) to (e), a line of continuance cards 11 (a) to (c). All of these cards are displayed with their indicia revealed to the player. Finally, there is a plurality, in this case 5, of gaming comparison cards 12(a) to (c) initially all face down. Card 12(a) is revealed and it matches card 10(c) and the player wins and receives a prize. Card 12(c) is then revealed and it matches card 10(a) recording a second win. Then card 12(c) is revealed which records a third win by matching with card 10(c) again. Finally, the game stops when the player reveals card 12(b) for which there is no match.

The present invention relates to a video card game machine comprising a visual display unit; a user control panel; acceptance means to receive an input payment from a player to allow the machine to be operated; and a control unit comprising: means for directing the playing of a game by displaying, face-up and face-down, a plurality of cards; and means for changing a face down card to a face-up card; and means for awarding prizes. The invention is also directed to a method of operating a video card game machine.

Generally, conventional video card game machines award prizes according to chance, with a minimum amount of skill involved. For example, in card games played in gaming establishments and the like, the player can play in such a manner as to take account of the odds by virtue, for example, of playing cards from a particular pack that have already been displayed, and so on. However, such a facility is generally not available with video gaming machines.

A further problem with many games of chance and skill, played on such video gaming machines, is that very often the player has one chance to win and then loses all his or her money, i.e. the token or money that has been inserted into the video card game machine to allow the machine to be operated. Sometimes, there is what is in effect a “neutral” prize, in the sense that the player may be allowed to continue playing the game, having another chance.

However, in many such games, the player does not have any real control over whether he or she continues to play, whether he or she accepts bets from the machine or whether, for example, having won a prize, he or she decides to wager that prize on winning a further prize at obviously improved odds. This is somewhat on the basis of a “double your money” option. However, generally, there is not enough opportunities for the player to interact with the machine.

The present invention directed towards overcoming these problems.

### STATEMENTS OF THE INVENTION

According to the invention, there is provided a video card game machine comprising:
a visual display unit;
a user control panel;
acceptance means to receive an input payment from a player to allow the machine to be operated; and
a control unit comprising: means for directing the playing of a game by displaying, face-up and face-down, a plurality of cards; and means for changing a face down card to a face-up card; and
means for awarding prizes;
   characterised in that:
the control unit comprises: means for displaying, face-up with the indicia thereon visible, a first number of winning cards;
means for displaying face-up a second number of continuance cards;
means for displaying face-down a further number of gaming comparison cards;
means, on a player operating the control panel, to cause one of the gaming comparison cards to be displayed;
means for comparing the displayed comparison card with each of the winning cards;
means for indicating that a prize winning comparison has been achieved;
means for determining a prize to be awarded on a game winning comparison being achieved;
means to deliver the prize to the player;
means for comparing the displayed comparison card with each of the continuance cards;
means for indicating that a game continuance comparison has been achieved;
means for indicating that at least one further free use of the gaming machine can be made without the need to provide further payment;
means to allow such use to take place;
means for terminating the game if no further free use of the gaming machine is displayed;

This allows a player control over the playing of the game.

In one embodiment of the invention, the control unit comprises means to allow the player choose which gaming comparison card is to be displayed. This further allows the player to control the game.

In a still further embodiment of the invention, means are provided to display to the player the number of remaining free uses of the gaming machine allowed arising out of one or both of a game continuance comparison and a game winning comparison has been achieved. This enhances the attractiveness of the game for the player.

In a still further embodiment of the invention, the means to deliver the prize to the player comprises:
means to display at least two different choices of prize to the player;
means to allow the player choose the prize; and
means to receive the choice and deliver the prize subsequently.

This allows the player again to control the game and does not simply deliver a prize, leaving the player no option as to whether he or she wishes to accept the prize or not.

In another embodiment of the invention, the means for terminating the game includes means for displaying all the remaining face down cards. In this way, the player can see that he or she made the wrong choice of a card when playing the game.

In a still further embodiment of the invention, the acceptance means comprises one or more of:
a keypad to accept an alpha numeric code,
a coin/token release mechanism; and
a credit/debit card acceptor means.

This allows very many ways for a player to play the game.

In a still further embodiment of the invention, the acceptance means comprises means to dispense coins and/or tokens. In this way, prizes can be awarded without any difficulty.

In accordance with the invention, there is provided a method of operating a video card game machine comprising:
means for directing the playing of a game by displaying face-up and face-down a plurality of cards;
means for changing a face-down card to a face-up card; and
means for awarding prizes;
   the method comprising:
displaying face-up with the indicia thereon visible, a first number of winning cards;
displaying face-up a second number of continuance cards;
displaying face-down a further number of gaming comparison cards;
the player causing one of the gaming comparison cards to be displayed face up; and

If one of the following events occurs, proceeding as laid out below:
(a) the gaming comparison card matches one of the winning cards, providing a prize for the player;
(b) the gaming comparison card matches one of the continuance cards and then allowing the player to continue the game at least one more time by causing a further game to be played; and
(c) the gaming comparison card does not match any of the displayed cards and the game is terminated.

In this method, in one way of carrying out the game, on providing a prize the player is afforded the option to continue the game by causing at least one more gaming comparison card to be displayed.

In a further method of carrying out the invention, there are five winning cards and three continuance cards, with five gaming comparison cards. Alternatively, there may be five sets of each card.

In carrying out the method according to the invention, when occurrence (a) arises and there are at least two comparison cards left to be played, the player is allowed have two more games. Alternatively, when occurrence (a) arises, the player is given two chances to continue to play the game and a prize.

In another embodiment of the invention, the player may elect to reject the prize and double a future prize if obtained.

In one method of carrying out the invention, the prize is a multiple of the amount of money paid to play the game.

In another method of carrying out the invention, on occurrence (a) arising, the player is afforded the option of rejecting the prize and betting the prize on winning a prize on the next play of the game, the control unit offering odds against the occurrence.

In accordance with this latter method of carrying out the invention, on the player electing to bet, the machine displays the odds.

In this method of carrying out the invention, the odds may be randomly chosen from a database of odds.

Further, the invention provides a computer program comprising program instructions to cause a computer to provide the means for carrying out the invention, as described above. Further, the invention comprises a computer program comprising program instructions for causing a computer to carry out the method, as described above. This computer program may be embodied in a computer memory, a read only memory or may be carried on an electrical carrier signal or on an optical carrier signal.

### DETAILED DESCRIPTION OF THE INVENTION

The invention will be more clearly understood from the following description of an embodiment thereof, given by way of example only, with reference to the accompanying drawings in which:

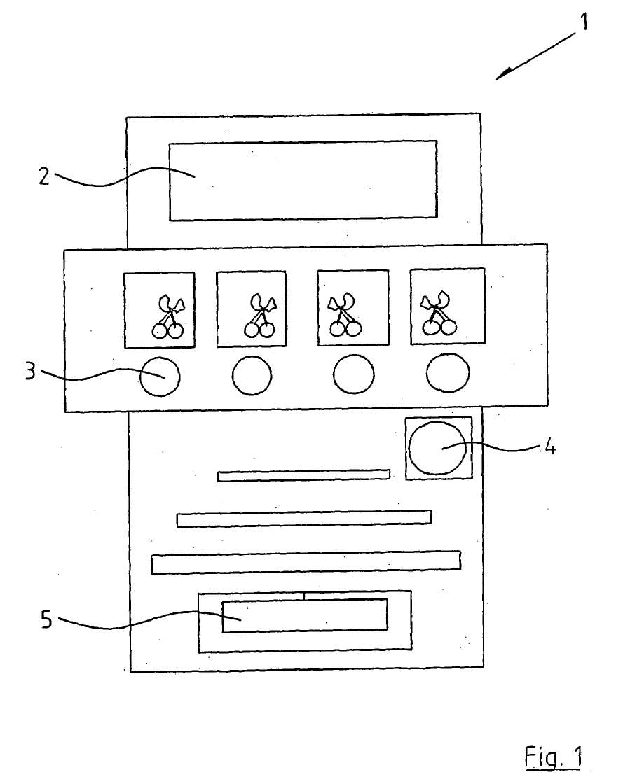

FIG. 1 is a diagrammatic front view of a video game machine according to the invention;

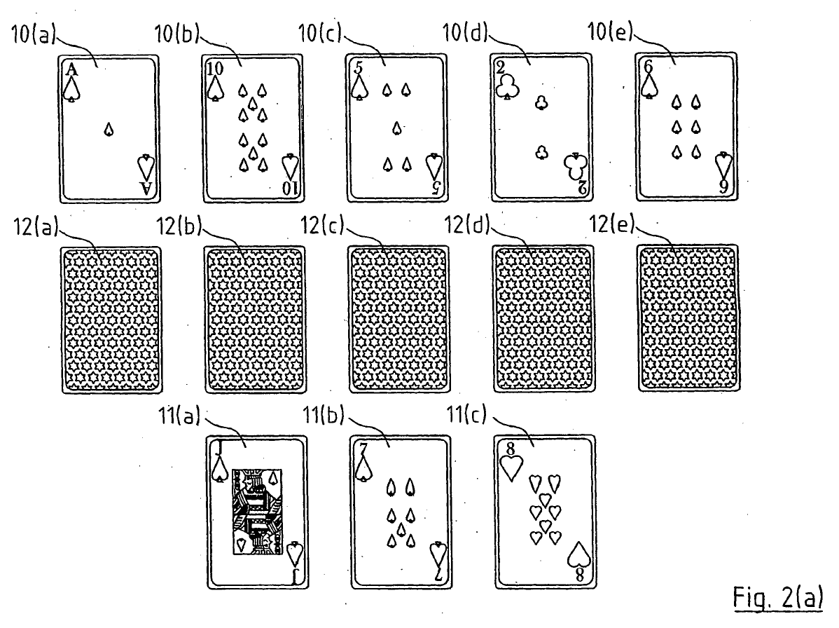

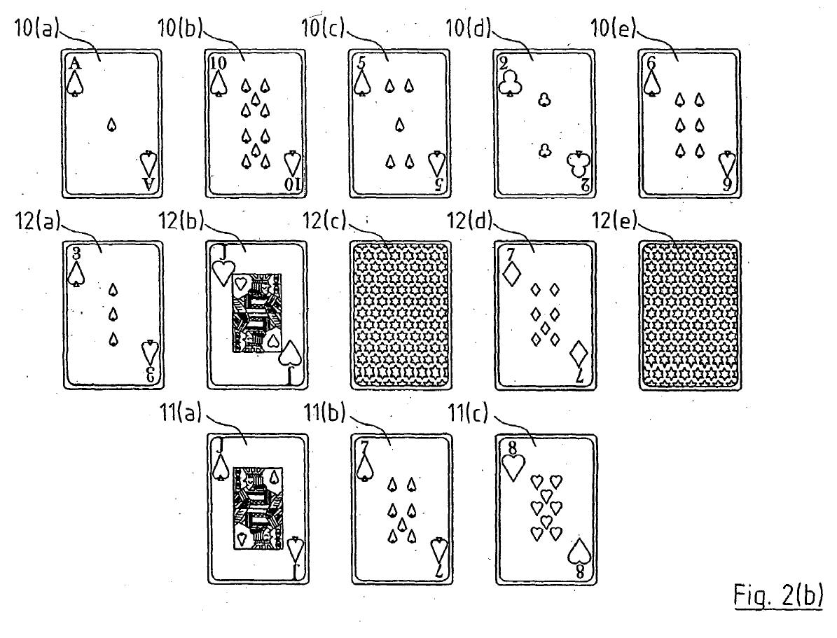

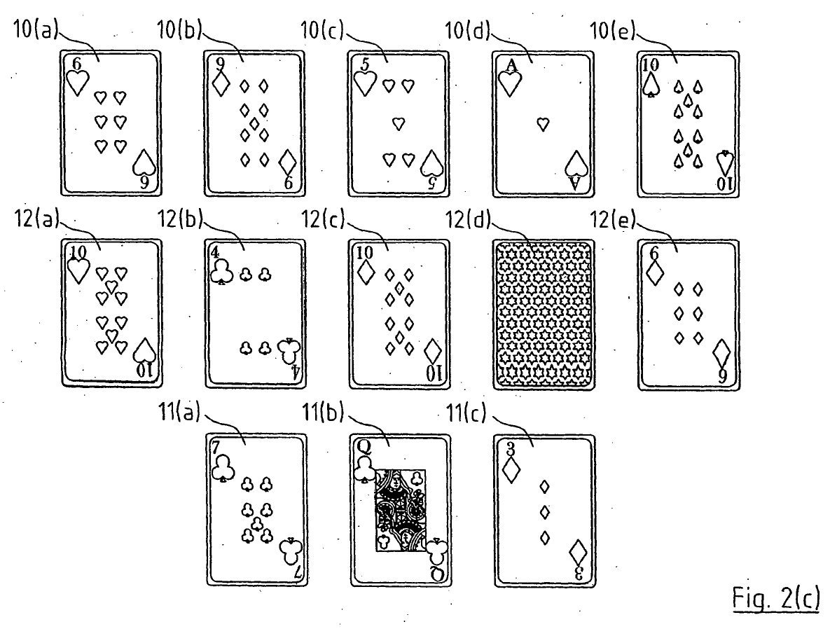

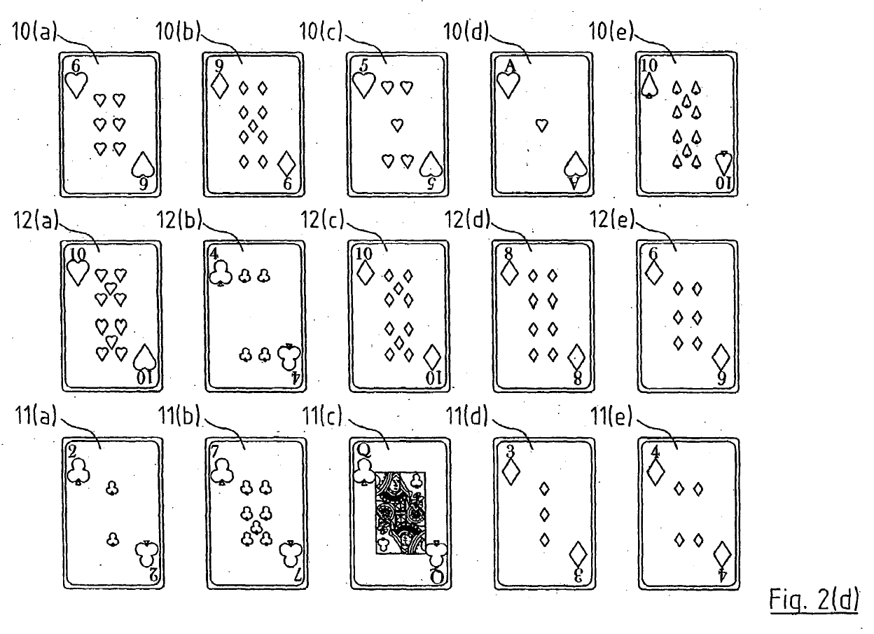

FIGS. 2(a) to (d) are various views of a visual display unit illustrating the game, and

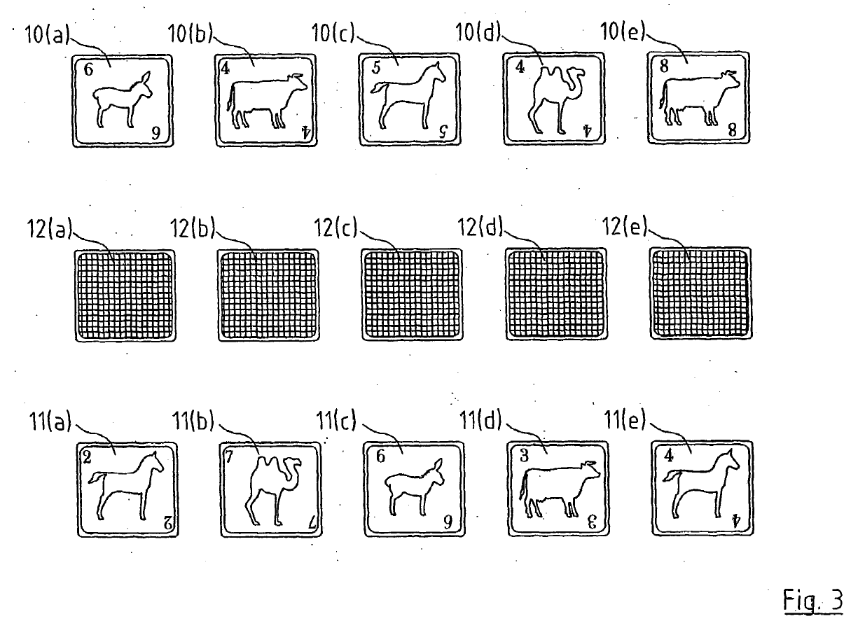

FIG. 3 is a view similar to FIG. 2 illustrating another way of playing the game.

Referring to the drawings and initially to FIG. 1, there is provided a video card game machine, indicated generally by the reference numeral 1, having a visual display unit (VDU) 2, a user control panel 3 for a control unit, not shown, means (4) for awarding a prize such as a coin/token delivery hopper, and acceptance means (5) to receive an input payment from a player such as a coin/token acceptor. The VDU 2 is adapted to provide various displays. Further, the video game machine 1 incorporates a control unit provided by a microprocessor, input and output ports, a programmable memory, for example, provided by an EPROM and a RAM circuit. Further, the video game machine 1 will incorporate a power pack and backup battery unit, all of which is conventional and is not illustrated.

To play and operate the video game machine 1, a player inserts coins or tokens into the acceptance means 5, in this case, the coin/token acceptor mechanism. When the coins have been accepted, the VDU 2 displays cards, as in FIG. 2, a number of cards from the one pack of cards, namely, a line of winning cards 10(a) to (e), a line of continuance cards 11(a) to (c). All of these cards are displayed with their indicia revealed to the player. Finally, there is a plurality, in this case 5, of gaming comparison cards 12(a) to (e) all face down.

Now referring to FIG. 2(b), the players uses the control panel 3 to cause the first gaming comparison card 12(b) to be exposed. When this gaming comparison card 12(b) is disclosed, it is seen from FIG. 2(b) that when compared with the continuance card 11(a), they are both jacks and the player is now allowed to play the game again. Then the card 12(d) is exposed and it matches card 11(b), allowing the game to continue. Then the player turns over another card 12(a) for which there is no match and the game terminates.

Referring to FIG. 2(c), another game proceeds as follows; card 12(a) is revealed and it matches card 10(e) and the player wins and receives a prize. Card 12(e) is then revealed and it matches card 10(a) recording a second win. Then card 12(c) is revealed which records a third win by matching with card 10(e) again. Finally, the game stops when the player reveals card 12(b) for which there is no match.

FIG. 2(d) illustrates a method of playing the game with five continuance cards. In this case, revealing the gaming comparison card 12(b) allows the game to continue and it only terminates when the card 12(d) is revealed.

Each time a player wins, he or she is awarded a prize and money is dispensed out the coin delivery hopper 4.

The above game was played with the one pack of cards. It will be appreciated that it would be possible to use more than one pack or even, for example, to have one pack of cards for each of the three sets of cards, namely, the winning cards 10, the continuance cards 11 and the gaming comparison cards 12. Then a match could only be achieved when the identical cards were revealed, that is to say, the two cards, when matched, would have to be, for example, both Heart 10 or alternatively could be matched in the same way as before. Similarly, jokers may be used as free cards once, in the sense they can be used to match with any other card.

Referring to FIG. 3, there is illustrated cards in the form of pictures of animals rather than conventional gaming cards.

The terms “card” and “playing card” are used in this specification to represent not just playing cards as used in conventional card games such as Brag, Whist, Poker and Bridge. The term is used to include colours, numbers, devices and pictures generally which may be displayed or hidden from a player's view.

Essentially, the control unit is a computer and will comprise means for directing the playing of a game and indeed all the operations involved therein. Thus, the control unit comprises means for displaying, face-up with indicia thereon visible, a first number of winning cards; means for displaying face-up a second number of continuance cards and means for displaying face-down a further number of gaming comparison cards. Then, the control unit further comprises means, on a player operating the control panel, to cause one of the gaming comparison cards to be displayed; means for comparing the displayed comparison card with each of the winning cards; means for indicating the prize winning comparison has been achieved; means for determining a prize to be rewarded and again a winning comparison being achieved; means to deliver the prize to the player; means for comparing the displayed comparison card with each of the continuance cards; means for indicating the game continuance comparison has been achieved; means for indicating that at least one further free use of the gaming machine can be made without the need to provide further payment; means to allow such use to take place; and means for terminating the game, if no further free use of the gaming machine is displayed. In other words, the control unit contains all the means to allow the video card game machine to be operated and it will be appreciated that all these means can be relatively easily supplied by computer programs, whether embodied in a computer memory, embodied in a read-only memory, carried on an electrical signal carrier or carried on an optical carrier signal. Further, it would be of little use to display all these means by a block diagram as the block diagram would not add anything to the understanding of the invention since such means, it will be appreciated by the reader, can be supplied by conventional programming.

Similarly, there are other means described throughout the specification, which means again can be easily provided by a suitably programmed computer. Similarly, any steps of any method for operating a video card game machine can be equally supplied by a computer program.

While we have suggested above that the prize can be a monetary prize, it equally well could be an opportunity to play the game a certain number of times again, to play a different game or to raise the stakes. For example, the player, by use of the control panel 3, could decide not to accept a prize but to play for some factor of the prize again. This will require some skill from the player such as, for example, suppose that already four of the comparison gaming cards have already been displayed, then a total number of twelve cards have been displayed. Presuming there has been no duplication, in the sense that the same card did not appear originally in either the winning cards or the continuance cards. There are thirty-six cards which could be exposed. The player has to calculate odds somewhat on the lines of: for the cards already recording a win or continuance, i.e. 4 cards exposed, there are only two more cards for each one of these that can be a match, i.e. 8 cards and for the remaining 4 cards exposed, you have 28 cards to match.

It will be appreciated that any form of acceptance means to receive an input payment from a player may be used. The payment from the player could, for example, be by way of a credit or debit card, in which case the acceptance means would be a credit or debit card acceptor means, or it could be a coin or token release mechanism or indeed could be keypad to accept an alphanumeric code. The payment does not have to actually be in currency.

There will be many ways in which the video card game machine may be operated and some of these have been described already. For example, while it has been stated above, that a gaming comparison card matches one of the winning cards providing a prize to the player, the player may be allowed to continue the game for at least one play which would be the more normal situation, but indeed for two or more plays, if it is so decided. Similarly, this may be changed when there is less than two comparison cards to be played. Then the player may only be allowed one additional game. Further, it may be decided that when, at the end, with all the gaming comparison cards exposed, the player achieves a match with a continuance cards, a totally new game may be provided for the player without any further payment.

The number and permutations of the manner in which the game may be played are many and will be readily appreciated by those skilled in the art. Further, while in the embodiment described above, a particular number of cards have been shown, equally well, the number of cards, for example, for winning, for continuance or for playing, can be altered. Further, while in the embodiment described above, the player was allowed expose which card he or she wished to expose, equally well, this could be provided randomly or indeed could be provided in a preset order.

It will also be appreciated that various types of prizes may be provided and indeed players may be given a choice of prizes.

In the specification the terms “comprise, comprises, comprised and comprising” or any variation thereof and the terms “include, includes, included and including” or any variation thereof are considered to be totally interchangeable and they should all be afforded the widest possible interpretation and vice versa.

The invention is not limited to the embodiment hereinbefore described, but may be varied in both construction and detail.

1. A video card game machine (1) comprising:
a visual display unit (2);
a user control panel (3);
acceptance means (5) to receive an input payment from a player to allow the machine to be operated; and
a control unit comprising: means for directing the playing of a game by displaying, face-up and face-down, a plurality of cards; and means for changing a face down card to a face-up card; and
means (4) for awarding prizes;
characterised in that:
the control unit comprises: means for displaying, face-up with the indicia thereon visible, a first number of winning cards;
means for displaying face-up a second number of continuance cards;
means for displaying face-down a further number of gaming comparison cards;
means, on a player operating the control panel, to cause one of the gaming comparison cards to be displayed;
means for comparing the displayed comparison card with each of the winning cards;
means for indicating that a prize winning comparison has been achieved;
means for determining a prize to be awarded on a game winning comparison being achieved;
means to deliver the prize to the player;
means for comparing the displayed comparison card with each of the continuance cards;
means for indicating that a game continuance comparison has been achieved;
means for indicating that at least one further free use of the gaming machine can be made without the need to provide further payment;
means to allow such use to take place;
means for terminating the game if no further free use of the gaming machine is displayed;

2. A video card game machine (1) as claimed in claim 1, in which the control unit comprises means to allow the player choose which gaming comparison card is to be displayed.

3. A video card gaming machine (1) as claimed in claim 1, in which means are provided to display to the player the number of remaining free uses of the gaming machine allowed arising out of one or both of a game continuance comparison and a game winning comparison has been achieved.

4. A video card game machine (1) as claimed in claim 1, in which the means to deliver the prize to the player comprises:
means to display at least two different choices of prize to the player;
means to allow the player choose the prize; and
means to receive the choice and deliver the prize subsequently.

5. A video card gaming machine (1) as claimed in claim 1, in which the means for terminating the game includes means for displaying all the remaining face down cards.

6. A video card game machine (1) as claimed in claim 1, in which the acceptance means (5) comprises one or more of: a keypad to accept an alpha numeric code; a coin/token release mechanism; and a credit/debit card acceptor means.

7. A video card game machine as claimed in claim 1, in which the acceptance means comprises means to dispense coins and/or tokens.

8. A method of operating a video card game machine comprising:
means for directing the playing of a game by displaying face-up and face-down a plurality of cards;
means for changing a face-down card to a face-up card; and
means for awarding prizes;
the method comprising:
displaying face-up with the indicia thereon visible, a first number of winning cards;
displaying face-up a second number of continuance cards;
displaying face-down a further number of gaming comparison cards;
the player causing one of the gaming comparison cards to be displayed face up; and
if one of the following events occurs, proceeding as laid out below:
(d) the gaming comparison card matches one of the winning cards, providing a prize for the player;
e) the gaming comparison card matches one of the continuance cards and then allowing the player to continue the game at least one more time by causing a further game to be played; and
f) the gaming comparison card does not match any of the displayed cards and the game is terminated.

9. A method as claimed in claim 8, in which on providing a prize, the player is afforded the option to continue the game by causing at least one more gaming comparison card to be displayed.

10. A method as claimed in claim 8, in which there are five winning cards and three continuance cards, with five gaming comparison cards.

11. A method as claimed in claim 8, in which there are five of each set of cards.

12. A method as claimed in claim 8, in which when occurrence (a) arises and there are at least two comparison cards left to be played, the player is allowed have two more games.

13. A method as claimed in claim 8, in which when occurrence (a) arises, the player is given two chances to continue to play the game and a prize.

14. A method as claimed in claim 8, in which the player may elect to reject the prize and double a future prize if obtained.

15. A method as claimed in claim 8, in which the prize is a multiple of the amount of money paid to play the game.

16. A method as claimed in claim 8, in which on occurrence (a) arising, the player is afforded the option of rejecting the prize and betting the prize on winning a prize on the next play of the game, the control unit offering odds against the occurrence.

17. A method as claimed in claim 16, in which on the player electing to bet, the machine displays the odds.

18. A method as claimed in claim 12, in which the odds are randomly chosen from a database of odds.

19. A computer program comprising program instructions to cause a computer to provide the means for carrying out the invention as claimed in claim 1.

20. A computer program comprising program instructions for causing a computer to carry out the method of claim 8.

21. A computer program as claimed in claim 19, embodied in a computer memory.

22. A computer program as claimed in claim 19, embodied in a read-only memory.

23. A computer program as claimed in claim 19, carried on an electrical carrier signal.

24. A computer program as claimed in claim 19, carried on an optical carrier signal.
